(19) United States
(12) Patent Application Publication
(10) Pub. No.: US 2009/0004354 A1
(43) Pub. Date: Jan. 1, 2009

(54) Artificial sweetener with high intensity sweetness

(76) Inventors: Joseph M. Coffield, Richmond Hill, GA (US); John E. Curry, Savannah, GA (US); Steven Michael Scott, Jupiter, FL (US)

Correspondence Address: EDWARDS ANGELL PALMER & DODGE LLP, P.O. BOX 55874, BOSTON, MA, 02205, US

(21) Appl. No.: 11/051,881

(22) Filed: Feb. 4, 2005

(51) Int. Cl. A23L 2/60

(52) U.S. Cl. 426/534; 426/548

(57) ABSTRACT

The present invention is directed to, among other things, an artificial sweetener and method of making the same composed of acesulfame potassium, crystalline maltitol and Neotame, which provides a high intensity sweetness, contributes no significantly unpleasant aftertaste, yields a sucrose-like taste to products in which it is incorporated, and has a sweetness power equivalent to about 600 times that of sucrose.

### BACKGROUND OF THE INVENTION

1. Field of the Invention

The present invention relates to a novel sweetener composition. In particular, the present invention relates to a sweetener composition with a high intensity sweetness.

2. Background of the Related Art

Sweeteners are a critical ingredient in the food supply. Development of convenience oriented foods has lead to increased consumption of sweeteners, while demand for diet food products has led to various attempts to reduce the sweetener contribution of calories and carbohydrates. These attempts primarily involve the use of artificial or high intensity sweeteners, such as saccharin and aspartame.

Many of the artificial sweeteners have a sweetening power that is significantly greater than that of natural sugars. Therefore, these artificial sweeteners are advantageously used for the sweetening of food, beverages, animal feed, pharmaceuticals and cosmetics. However, these prior art artificial sweeteners have the disadvantage that they have a more or less strong aftertaste, especially in higher concentrations. Additionally, the flavor quality of the sweetness imparted by these prior art sweeteners differs from that of sucrose, which serves as a standard for the evaluation of the sweetness, simply because people have been accustomed to it for such a long time.

Accordingly, there exists a need for an artificial sweetener that can provide a high sweetness power and be used in the sweetening of food, beverages, pharmaceuticals and cosmetics, among other things. There also exists a need for a high intensity artificial sweetener that does not contribute a strong aftertaste, and moreover, imparts a taste that more closely mimics the taste of sucrose.

### BRIEF SUMMARY OF THE INVENTION

The present invention improves upon and solves the problems associated with the prior art by providing, among other things, an artificial sweetener that meets the needs listed above.

In particular, the present invention is directed to an artificial sweetener that provides a high intensity sweetness, contributes no significantly unpleasant aftertaste and yields a sucrose-like taste to products in which it is incorporated. The present invention also discloses a method of imparting a sweet taste into sweeteners, food, beverages, pharmaceuticals, cosmetics or other products that might benefit from having a sweet taste. The present invention is also directed to sweeteners, food, beverages, pharmaceuticals, cosmetics, or other products containing an artificial sweetener formed in accordance with the present invention.

In one embodiment, the artificial sweetener of the present invention includes a first sweetener, a second sweetener having a higher sweetness power than the first sweetener, and a carrying agent. The first sweetener, second sweetener and carrying agent are combined in amounts or ratios with respect to each other so that the resulting artificial sweetener composition yields an overall sweetness power equivalent to about 600 times that of sucrose.

In a preferred exemplary embodiment, an artificial sweetener fabricated in accordance with the present invention is composed of acesulfame potassium, crystalline maltitol and Neotame (i.e., N-[N-(3,3-dimethylbutyl)-L-aspartyl]-L-phenylalanine 1-methyl ester—available from The Nutrasweet Company), among other things. The aforementioned components are included in amounts so that the blend preferably results in an artificial sweetener having a sweetness power equivalent to about 600 times that of sucrose (i.e., sugar).

These and other aspects of the present invention will become more readily apparent to those having ordinary skill in the art from the following detailed description of the invention.

### DETAILED DESCRIPTION OF THE INVENTION

Reference is now made to the following detailed description which has been provided to illustrate preferred and exemplary embodiments of the present invention, but is not intended to limit the scope of the present invention.

The present invention provides an artificial sweetener composition which includes at least one high intensity sweetener with a carrying agent. Preferably, the artificial sweetener of the present invention includes a first sweetener, a second sweetener, and a carrying agent, wherein the second sweetener has a higher sweetness power than the first sweetener, and more preferably, the second sweetener has a sweetness power which is of a substantial magnitude (e.g., several 100 times) greater than the first sweetener.

The first and second sweeteners may be chosen based on compatibility or the potential for a beneficial synergistic effect. The first and second sweeteners selected provide a high sweetness quality without a lingering or bitter aftertaste. Preferably, the first sweetener has the characteristic of a sweetness profile which evolves rapidly and fades slowly, while the second sweetener provides the high sweetness power behind or underneath the lasting taste of the first sweetener.

In a non-limiting embodiment, an artificial sweetener in accordance with the present invention includes a first sweetener, which is at least 100 times sweeter than sugar, and a second sweetener at least 2000 times sweeter than sugar, and a carrying agent in ratios that preferably result in a sweetness power equivalent to about 600 times that of sugar. The second sweetener preferably has a sweetness 10 times greater than the sweetness of the first sweetener.

In a preferred embodiment, acesulfame potassium having a sweetness approximately 200 times that of sugar is mixed with Neotame having a sweetness approximately 8000 times that of sugar. In a preferred embodiment, the first sweetener has a sweetness profile which evolves rapidly and then fades slowly.

The carrying agent used in compositions of the present invention is preferably a polyol, such as sorbitol or erythritol, or mixtures thereof, and more preferably, crystalline maltitol.

Preferably, the artificial sweetener of the present invention includes acesulfame potassium in a range from about 64.8% to about 79.2%, Neotame in a range from about 5.6% to about 6.8%, and a carrying agent, such as maltitol, in a range from about 19.6% to about 23.99% by weight. In an exemplary embodiment, the artificial sweetener of the present invention includes acesulfame potassium at about 72%, Neotame at about 6.12% and maltitol at about 21.81% by weight.

An exemplary method of making an artificial sweetener of the present invention includes mixing the carrying agent with the first sweetener having the highest sweetness power, adding the second sweetener with the lower sweetness power to the mixture of the carrying agent first sweetener, and then blending the entire composition to form the artificial sweetener. Preferably, the method of the present invention is carried out with substantially dry ingredients.

The high sweetness power of the artificial sweetener permits small amounts thereof to be used as an additive. Therefore, use of the artificial sweetener of the present invention has a negligible effect on the carbohydrate and calorie amounts per consumer serving size and applicable regulations relating to nutritional labeling requirements, even though carbohydrates and calories are present.

For example, assume a 20 ounce carbonated beverage has a serving size of 8 ounces and sugar equivalent of 30 grams. Thus, 30 grams of sugar would be equivalent to 0.05 grams of the preferred embodiment of the artificial sweetener (i.e., an artificial sweetener having a sweetness power equivalent to 600 times that of sugar). Since there are 0.2164 carbohydrates per gram, multiplying that number by 0.05 grams yields 0.01 grams of carbohydrates per serving of the beverage. There are 0.4544 calories per gram, thus there are 0.02 calories per serving of the beverage.

According to 21 CFR §101.9, calories per serving should be expressed to the nearest 5-calorie increment up to and including 50 calories, and 10 calorie increment above 50 calories, except that amounts less than 5 calories may be expressed as zero. Thus, in the above example and in accordance with the aforementioned regulation, the amount of calories per serving of the carbonated beverage can be expressed as zero.

Similarly, 21 CFR §101.9 proscribes that a statement of the number of grams of total carbohydrates in a serving be expressed to the nearest gram, except that if a serving contains less than one gram, the statement “Contains less than 1 gram” or “less than 1 gram” may be used as an alternative, or if the serving contains less than 0.5 gram, the content may be expressed as zero. Thus, in the above example and in accordance with the aforementioned regulation, the amount of carbohydrates per serving of the carbonated beverage can also be expressed as zero.

Although exemplary and preferred aspects and embodiments of the present invention have been described with a full set of features, it is to be understood that the disclosed artificial sweetener and method of making the same may be practiced successfully without the incorporation of each of those features. Thus, it is to be further understood that modifications and variations may be utilized without departure from the spirit and scope of this inventive artificial sweetener and method of making the same, as those skilled in the art will readily understand. Such modifications and variations are considered to be within the purview and scope of the appended claims and their equivalents.

What is claimed as new and desired to be protected by Letters Patent of the United States is:

1. An artificial sweetener comprising:
a) a first sweetener;
b) a second sweetener; and
c) a carrying agent,
wherein the second sweetener has a higher sweetness power than the first sweetener, and the first sweetener, second sweetener and carrying agent are included in a ratio such that composition has an overall sweetness power equivalent to about 600 times that of sucrose.

2. An artificial sweetener as recited in claim 1, wherein the second sweetener has a sweetness power which is at least 10 times greater than the first sweetener.

3. An artificial sweetener as recited in claim 1, wherein the first and second sweeteners are chosen to have the optimal synergistic effect to provide a high sweetness quality without a lingering or bitter aftertaste.

4. An artificial sweetener as recited in claim 1, wherein the first sweetener has a sweetness profile that evolves rapidly and fades slowly.

5. An artificial sweetener as recited in claim 1, wherein the second sweetener is Neotame.

6. An artificial sweetener as recited in claim 1, wherein the first sweetener is acesulfame potassium.

7. An artificial sweetener as recited in claim 1, wherein the carrying agent is a polyol.

8. An artificial sweetener as recited in claim 1, wherein the carrying agent is crystalline maltitol.

9. An artificial sweetener comprising:
a) Neotame;
b) acesulfame potassium; and
c) a carrying agent,
wherein the Neotame, acesulfame potassium and carrying agent are included in a ratio such that the composition has an overall sweetness power equivalent to about 600 times that of sucrose.

10. An artificial sweetener as recited in claim 9, wherein the carrying agent is a polyol.

11. An artificial sweetener as recited in claim 9, wherein the carrying agent is crystalline maltitol.

12. An artificial sweetener as recited in claim 9, wherein the amount of Neotame ranges from about 5.6% to about 6.8% by weight.

13. An artificial sweetener as recited in claim 9, wherein the amount of acesulfame potassium ranges from about 64.8% to about 79.2% by weight.

14. An artificial sweetener as recited in claim 11, wherein the amount of maltitol ranges from about 19.6% to about 23.99% by weight.

15. An artificial sweetener as recited in claim 11, wherein the amount of maltitol by weight is about 21.81%, the amount of acesulfame potassium by weight is about 72%, and the amount of Neotame by weight is about 6.12%.
